(19) United States
(12) Patent Application Publication
(10) Pub. No.: US 2008/0228596 A1
(43) Pub. Date: Sep. 18, 2008

(54) Method and system for conducting a sale on the Internet with discounts as a function of time

(76) Inventor: Naim J. Elias, South Barrington, IL (US)

Correspondence Address: QUARLES & BRADY LLP, 411 E. WISCONSIN AVENUE, SUITE 2040, MILWAUKEE, WI, 53202-4497, US

(21) Appl. No.: 11/717,233

(22) Filed: Mar. 13, 2007

(51) Int. Cl. G06Q 30/00

(52) U.S. Cl. 705/27

(57) ABSTRACT

The invention provides a method and website for displaying a product for sale at a starting price selected by the seller and adjusting the price downward in at least two percentage increments, wherein the percentages are preselected by the website to be applied at increments of time during a limited term of sale selected by the seller. Buyers can select a current price or a future discounted price. When a current price has been offered the offer is accepted and the sale is completed in a usual and customary manner.

### TECHNICAL FIELD

This invention relates to methods and systems for allowing sellers to list and offer various goods or services on an Internet website for purchase by buyers who access the website.

### DESCRIPTION OF THE BACKGROUND ART

Internet auction sites, particularly eBay, are well known in the art. Generally, eBay operates as an auction website where products are listed for a specific time and potential buyers bid on the items until a closing date and time when the highest recorded bid is accepted to form a contract for sale. The sellers are charged a fee for listing the items.

In this description, the term “products” shall mean either goods or services.

Various other kinds of selling methods have been adapted to the Internet, including reverse auctions, Dutch auctions, fixed price sales and best offer sales.

Dynamic pricing methods have been used to liquidate quantities of items as disclosed in Godin, U.S. Pat. No. 5,890,138; Godin, U.S. Pat. No. 6,266,652 and Kaminksy, U.S. Pat. Pub. No. 2001/0047308. Cicotelli, U.S. Pat. Pub. No. 2006/0080183 discloses controlling price according to an algorithm based on time and level of sales for multiple quantities of an item.

Goel, U.S. Pat. Pub. No. 2006/0143109 discloses an auction website and method that includes a clearance section. In the clearance section, prices may be reduced from a fixed price until the item is sold. In such a system, the seller is often allowed to control the time and method of applying discounts to the fixed price.

Chin, U.S. Pat. Pub. No. 2006/0122928 discloses a sales system that employs falling prices according to the control of an operator or based on “sales logic.”

Although high volume website markets like eBay are popular, there is increasingly a need for competition in Internet marketplace selling based on fees, ease of use and navigation, reaching local or specialized markets and providing a service to non-commercial sellers.

It is to respond to these needs that the present invention has been made.

### SUMMARY OF THE INVENTION

The invention provides a method and website for displaying the product for sale at a starting price selected by the seller, and adjusting the price downward in at least two percentage increments, wherein the percentages are preselected by the website to be applied at increments of time during a limited term of sale selected by the seller.

In a more particular aspect of the invention the increments correspond to increments of time and include at least four increments of time.

In a more particular aspect of the invention, the percentage for adjusting the price downward for each increment is approximately a 10% reduction from a previous price. By “approximately” is meant plus or minus one percent. In broader aspects of the invention, other percentages could be used.

In a more particular aspect of the invention, the limited term of sale is selected by the seller from a range from less than ten days to no more than a term limit such as sixty days.

In a more particular aspect of the invention, the increments of time are determined by dates entered by the seller when listing an item for sale and may be selected for unequal increments. The increments of time could be equal or unequal as to time.

It is a further aspect of the invention that the seller cannot control the percentage for adjusting the price downward or the number of increments of time for adjusting the price downward. The adjusting the price downward in at least two percentage increments is mandatory and is not optional with the seller.

In a further aspect of the invention, there is a minimum sales price required of any item to be sold on the website, such as $10.00, for example.

The invention is applicable to sale of both goods and services. The goods and services are available for search by categories, such as “local,” “nationwide,” “worldwide” or by zip code area. The term sale should be understood to include leasing or renting for fixed periods as well.

The invention also relates to a website for practicing the method of the invention.

Other objects and advantages of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a block diagram of a website for practicing the method of the present invention;

FIG. 2 is a screen display for a seller for listing an item for sale on a website;

FIG. 3 is a screen display for searching for products being offered for sale to buyers; and

FIG. 4 is a “for sale” screen display for an individual product.

### DETAILED DESCRIPTION OF THE PREFERRED EMBODIMENTS

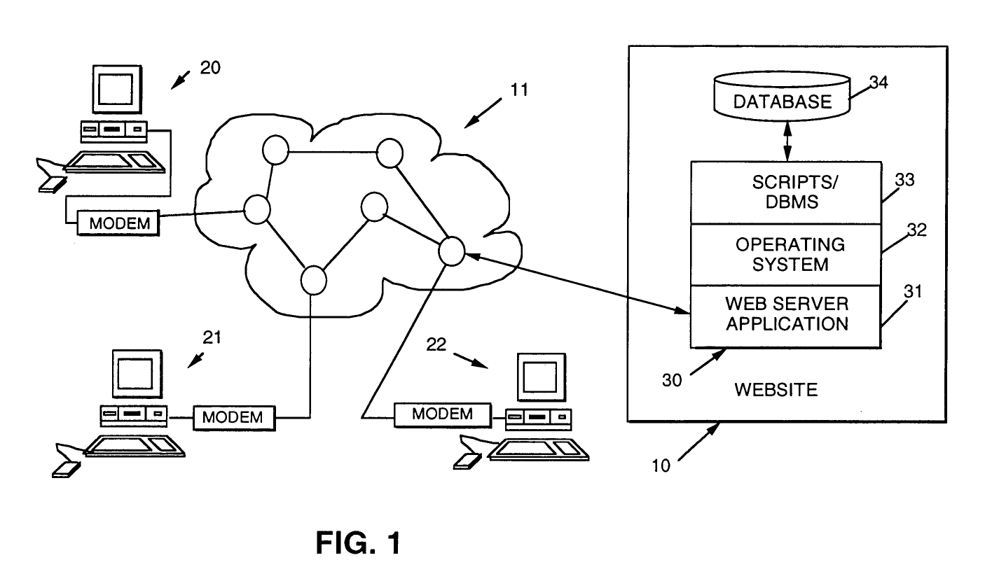

Referring to FIG. 1, in a preferred embodiment of the system of the current invention users can access the website 10 through their computers 20, 21 and 22 and by communicating through the Internet 11, which is represented as a collection of nodes in FIG. 1. The users can access the website 10 using a computer 20, 21 and 22 or a handheld computing device, such as a PDA or a cell phone, or any other device that allows an individual to access a website through the Internet. In addition, the website 10 can be accessed through a local area network, a wide area network, or any other method that allows access to a website by an individual.

Referring to FIG. 1, the system of the present invention includes a server computer 30 which is capable of hosting a website on the World Wide Web of networks (also known as the Internet) and running Sun Solaris, Windows XP, Linux or another compatible operating system 32. In addition to a stand-alone website 30, the invention can be hosted in a larger operation with other websites, as is well known in the art. Firewalls and other security measures of a type known in the art may be incorporated in the website 10, but are not shown.

The user computers 20, 21 and 22 use well known browser software such as Netscape Navigator or Microsoft Explorer. The server 30 runs a web server application 31 under an operating system 32 as described above to communicate with the user computers 20, 21 and 22 through suitable firewalls of a type known in the art (not illustrated). Apache is a commonly used Web server application 31 and Microsoft's Internet Information Server (IIS) is also commonly used.

The web server application program 31 manages application requests, and transmits requested information to the user computers 20, 21 and 22. The web server application program 31 enables the server 30 to keep track of which prospective customer is associated with each specific information request, and ensures that the information is properly transmitted.

The server 30 also manages a database 34, stored in a memory storage device of suitable capacity. The database 34 is managed by a database management (DBMS) program 33, such as MY SQL or Oracle. A DBMS program 33 is configured and characterized by scripts that define the database organization and execute database management functions. The DBMS program 33 also includes certain utility routines. The basic architecture provides a collection of web pages, which are called up and transmitted to users accessing the site.

The invention is first embodied in a website known by its URL, for example, “Website.com.” In fact, the assignee more particularly offers the service herein under the trade designation “4Sale4Now.com.” As will become apparent, the organization of the website 30 can be replicated within the site in the form of affiliate sites, and can also be set up in mirror sites or sites that are accessed with URL's other than those identified herein.

Although the website 10 is described herein as residing on a single computer 30, there are many other suitable website configurations involving multiple computers.

The server 30 transmits web pages to the user computers 20 using the above described programming. This web server application 31 manages application requests for the website 10, and transmits requested information to the user's computer 20. The program enables the server 30 to keep track of which user computer 20, 21 or 22 is associated with each specific information request, and ensures that the information is properly transmitted. The web server program 31 also interfaces with the scripts which make up the DBMS program 33.

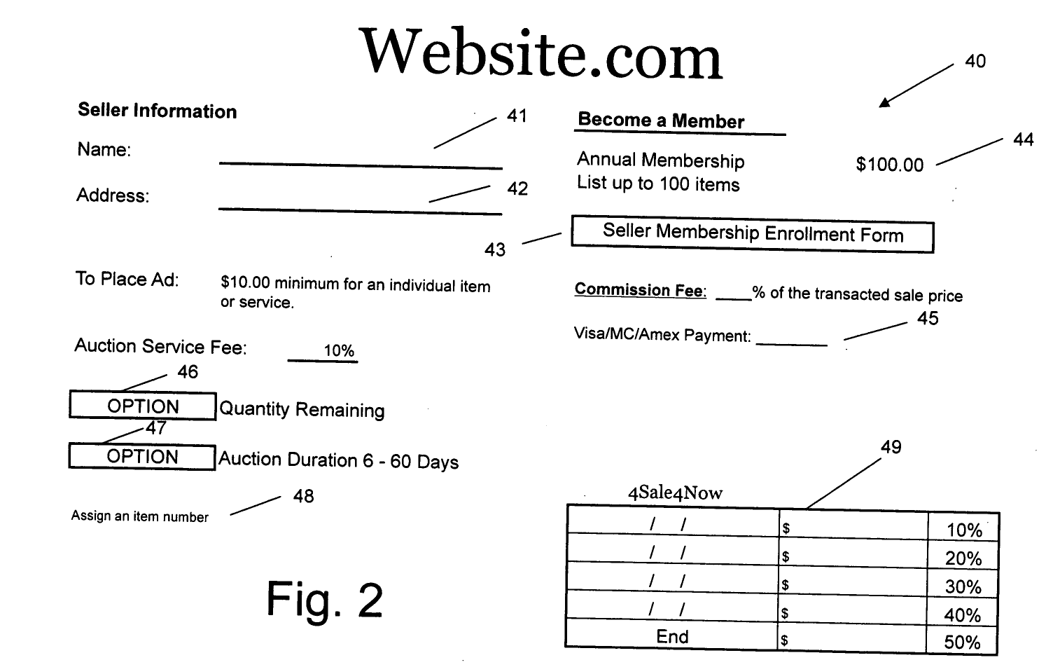

Referring to FIG. 2, the user enters a URL (uniform resource locator) address in a web browser and executes a “go” or “execute” operation in one of several ways known in the art to reach the website of the present invention. Upon reaching the website 10, and after any optional entry screen, a screen display 40 is displayed to users to offer them an opportunity to become members. Memberships are required of both buyers and sellers making this website a “membership only” website for buying and selling activities as opposed to a public website. The user is requested to enter name and address information in respective fields 41 and 42. A link 43 is provided to access a seller membership enrollment form. A membership fee 44 is displayed and this can be paid by credit card in a manner known in the art, as represented by a link 45. Other terms of membership such as a minimum price for items listed on the website and the auction service fee are displayed as well as fields to list an item for sale. Two types of sales are represented by links 46 and 47, a sale where the price is based on the quantity remaining and a sale of variable selected duration from at least six (6) days to no more than sixty (60) days.

FIG. 2 also shows a field 48 where the sale item will be assigned an item number. There is also a table 49 of predefined price reduction increments, in this example, 10%, 20%, 30%, 40% and 50%. The seller selects dates by which these price reductions are applied or the system may allocate dates based on the user's total duration of sale.

There are to be at least two percentage price reductions, although four price reductions over increments of time are preferred. At least two percentage increments are mandatory and are not optional with the seller. The seller cannot control the number of increments of time for adjusting the price downward; this is selected by the operator of the website 10. Although the percentage for adjusting the price downward for each increment is approximately a 10% reduction (plus or minus 1%) from a previous price, other percentages can be selected, although equal increments of price reduction are preferred. The seller cannot control the percentage for adjusting the price downward; this is selected by the operator of the website 10. The time increments can be equal in duration or unequal.

To list an item for sale an item number is assigned to a description and an optional photo or photos provided by the seller. The pricing schedule 49 used by the website determines the price and percentage reduction per time increment. The seller selects a starting price. The seller is also allowed to set the dates on which the reductions go into effect.

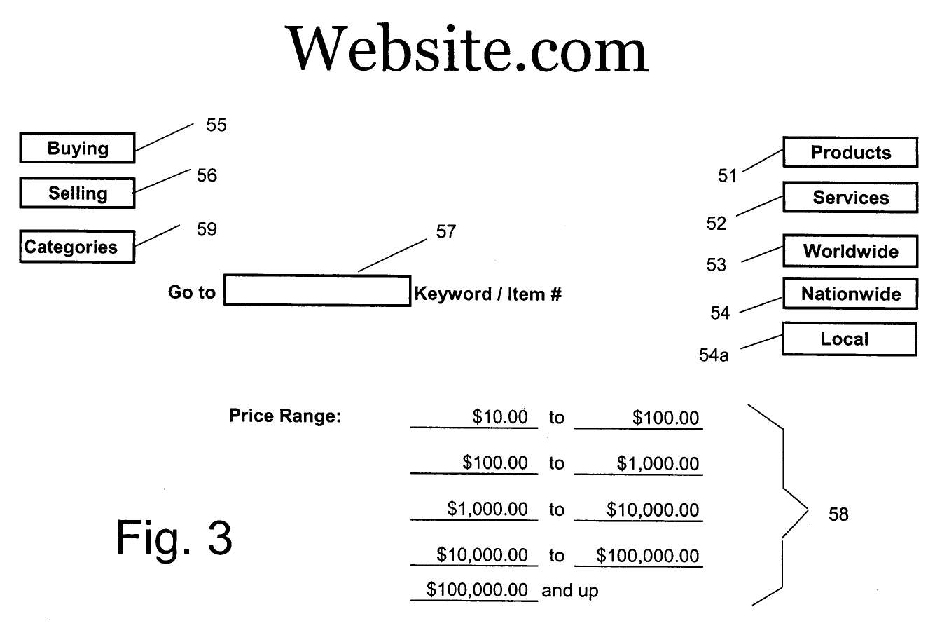

FIG. 3 shows a category organization screen display 50 through which a user can navigate to pages with groups of products (button 51) or services (button 52) offered either worldwide (button 53), nationwide (button 54), local (button 54a) either for buying (button 55) or selling (button 56). The buttons 51 to 56 are linked to hyperlinks to appropriate web pages in the system and are selected and activated to navigate to these web pages. There is also a keyword search entry in a data box 57 that is also available to navigate to an appropriate web page with that item. There are also selections 58, 59 to limit the search to items in certain price ranges.

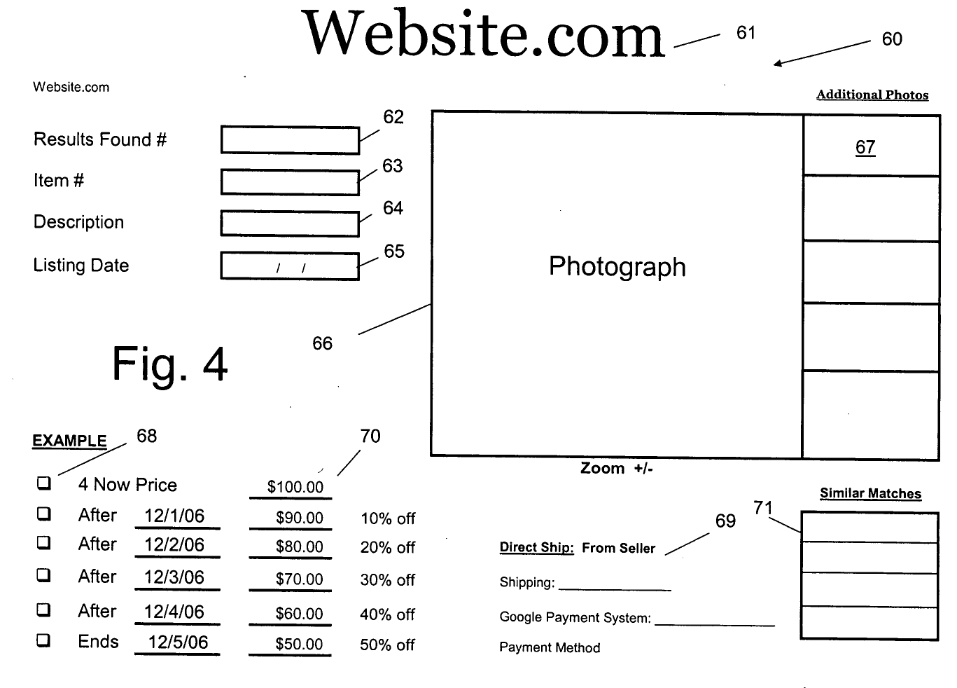

FIG. 4 shows an individual item listing screen display 60 having a banner 61 and display fields 62-65 for number of results found in a search, the item number of the item being viewed, a description or category field, and a date of listing. A photograph field 66 holds a main photo of the item any additional thumbnail photos 67. There is also a zoom feature for adjusting the view of the photo.

There are several check boxes 68 where a buyer can buy the item for the “4 Now” price or current price or for a reduced price in the future, if the item is not purchased before that time for a then current price. Shipping information and payment methods are also listed in an area 69 on the individual item listing. In the pricing section 70, it can be seen how the price is reduced at percentages and increments of time determined at the time the item was listed. There are also lists or thumbnail photos of similar items 71 with hyperlinks to induce the buyer to review additional items.

Assuming the buyer makes a successful offer that is accepted according to the terms of the listing, a notice of sale will be sent to the buyer. The buyer then arranges for a payment through credit card or other well known methods and the item will be shipped according the shipping information.

This has been a description of the preferred embodiments, but it will be apparent to those of ordinary skill in the art that variations may be made in the details of these specific embodiments without departing from the scope and spirit of the present invention, and that such variations are intended to be encompassed by the following claims.

I claim:

1. A method for offering a product for sale through communication through the Internet to a website, the method comprising:
displaying the product for sale at a starting price selected by the seller; and
adjusting the price downward in at least two percentage increments, wherein the percentages are preselected by the website to be applied at increments of time during a limited term of sale selected by the seller.

2. The method as recited in claim 1, wherein the increments correspond to increments of time and include at least four increments of time.

3. The method as recited in claim 2, wherein the percentage for adjusting the price downward for each increment is approximately a 10% reduction from a previous price.

4. The method as recited in claim 3, wherein the limited term of sale is selected by the seller from a range from less than ten days to no more than sixty days.

5. The method as recited in claim 3, wherein the increments of time are equal in duration.

6. The method as recited in claim 3, wherein the increments of time are determined by dates entered by the seller when listing an item for sale and may be selected for unequal increments.

7. The method as recited in claim 1, wherein the seller cannot control the percentage for adjusting the price downward.

8. The method as recited in claim 1, wherein the seller cannot control the number of increments of time for adjusting the price downward.

9. The method as recited in claim 1, wherein the adjusting the price downward in at least two percentage increments is mandatory and is not optional with the seller.

10. The method as recited in claim 1, wherein there is a minimum sales price required of any item to be sold on the website.

11. The method of claim 1, wherein the product is an item of goods.

12. A website for offering a product for sale through communication through the Internet, the website comprising:
application program instructions for communicating a screen display to a buyer's computing device that shows the product for sale at a starting price selected by the seller; and
application program instructions for automatically adjusting the price downward in at least two percentage increments, wherein the percentages are preselected by the website to be applied at increments of time during a limited term of sale selected by the seller at a time of listing the product for sale.

13. The website as recited in claim 12, wherein the increments correspond to increments of time and include at least four increments of time.

14. The website as recited in claim 13, wherein the percentage for adjusting the price downward for each increment is approximately a 10% reduction from a previous price.

15. The website as recited in claim 13, wherein the limited term of sale is selected by the seller from a range from less than ten days to no more than sixty days.

16. The website as recited in claim 13, wherein the increments of time are equal in duration.

17. The website as recited in claim 13, wherein the increments of time are determined by dates entered by the seller when listing an item for sale and may be selected for unequal increments.

18. The website as recited in claim 12, wherein the seller cannot control the percentage for adjusting the price downward.

19. The website as recited in claim 12, wherein the seller cannot control the number of increments of time for adjusting the price downward.

20. The website as recited in claim 12, wherein the adjusting the price downward in at least two percentage increments is mandatory and is not optional with the seller.

21. The website as recited in claim 12, wherein there is a minimum sales price required of any item to be sold on the website.

22. The website as recited in claim 12, wherein the product is an item of goods.
